(19) United States
(12) Patent Application Publication
(10) Pub. No.: US 2014/0170419 A1
(43) Pub. Date: Jun. 19, 2014

(54) METHOD OF COATING A CHROME PLATED PART

(71) Applicant: GM GLOBAL TECHNOLOGY OPERATIONS LLC, Detroit, MI (US)

(72) Inventors: Matthew E. Carroll, Grosse pointe woods, MI (US); Bradley Tice, Clarkston, MI (US); Ronald S. Lozon, Sterling Heights, MI (US)

(73) Assignee: GM Global Technology Operations LLC, Detroit, MI (US)

(21) Appl. No.: 13/716,955

(22) Filed: Dec. 17, 2012

(51) Int. Cl. B05D 7/14

(52) U.S. Cl. CPC B05D 7/14
USPC 428/420; 427/327; 427/535; 427/539

(57) ABSTRACT

One variation may include a method including providing a substrate having a layer comprising chrome thereon, the chrome having exposed surface; exposing the layer comprising chrome to a gas comprising ionized oxygen to activate the exposed surface of the chrome to provide an activated surface; applying a coating over the activated surface so that the coating is adhered to the layer comprising chrome, and wherein the coating is at least one of a primer, clear coat, tinted clear coat or opaque paint.

### TECHNICAL FIELD

The field to which the disclosure generally relates to includes methods of adhering a coating to a chrome plated part.

### BACKGROUND

Adhering a coating to a chrome plated part can be problematic.

### SUMMARY OF ILLUSTRATIVE VARIATIONS OF THE INVENTION

One variation may providing substrate having a layer comprising chrome thereon, the chrome having exposed surface; exposing the layer comprising chrome to a gas comprising ionized oxygen to activate the exposed surface of the chrome to provide an activated surface; applying a coating over the activated surface so that the coating is adhered to the layer comprising chrome, and wherein the coating is at least one of a primer, clear coat, tinted clear coat or opaque paint.

Another variation may Include a process comprising: providing a substrate having a layer comprising chrome thereon, the chrome having exposed surface; exposing the layer comprising chrome to a gas comprising ionized oxygen to activate the exposed surface of the chrome to provide an activated surface; contacting the activated surface with a coupling agent to provide a group bonded to the layer comprising chrome to provide a coupled surface; applying a coating over the coupled surface so that the coating is adhered to the layer comprising chrome.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1A illustrates a method resulting in a substrate having a layer including chrome thereon according to at least one variation of the invention.

FIG. 1B illustrates a method resulting in a substrate having a layer including chrome thereon being activated by exposing the chrome to a gas including ionized oxygen according to at least one variation of the invention.

FIG. 1C illustrates a step in a method including contacting the activated surface with a coupling agent to provide a group bonded to the layer including chrome to provide a coupled surface according to at least one variation of the invention.

FIG. 1D illustrates a method including applying a primer over the coupled surface according to at least one v nation of the invention.

FIG. 1E illustrates a method including applying a coating over the coupled surface so that the coating is adhered to the layer including chrome according to at least one variation of the invention.

FIG. 2 illustrates a method including applying a second primer to the first primer before applying a coating over the coupled surface so that the coating is adhered to the layer including chrome according to at least one variation of the invention.

FIG. 3 illustrates a method including exposing a layer including chrome to a gas including ionized oxygen to activate the exposed surface of the chrome to provide an activated surface and applying a coating over the activated surface so that the coating is adhered to the layer including chrome according to at least one variation of the invention.

FIG. 4 illustrates a method of applying at least a first primer and a second primer over the layer including chrome which has not been activated prior to applying a coating over the primers so that the coating is adhered to the layer including chrome.

### DETAILED DESCRIPTION OF ILLUSTRATIVE VARIATIONS OF THE INVENTION

The following description of the embodiment(s) is merely illustrative in nature and is in no way intended to limit the invention, its application, or uses.

It has been discovered that substrate having a layer including chrome thereon, such as a plated chrome layer may be exposed to a gas including ionized oxygen to activate the exposed surface of the layer including chrome and to provide an activated surface. Thereafter, coating may be applied over the activated surface so that the coating is adhered to the layer including chrome. The activation of the exposed surface of the layer including chrome enhances the adhesion properties of coating such as clear coats, tinted clear coats, opaque paints including pigments, and/or primers. The adhesion of the coating to the layer including chrome is further enhanced if a coupling agent is applied to the activated surface of the layer including chrome.

It is also been discovered that by activating the surface of the layer including chrome by exposing the chrome to a gas including ionized oxygen the activated surface product may be stored for a substantial period of time before it is necessary to apply a coating to the activated surface or to apply a coupling agent to the activated surface. In a number of variations, the activated surface product may be stored for at least one month, at least three months, at least six months, or more than nine months prior to applying a coating over the activated surface or applying a coupling agent to the activated surface.

It has also been discovered that by activating the surface of the layer including chrome by exposing the chrome to a gas including ionized oxygen to activate the surface of the chrome and thereafter applying a coupling agent to the activated surface, the product including the coupled surface may be stored in select variations for at least three hours, at least eight hours, at least 24 hours, at least 72 hours, or at least 96 hours prior to applying a coating over the coupled surface.

The above described discoveries are significant in terms of solving logistics, timing and storage problems associated with high production applications such as, but not limited to, the production of vehicles.

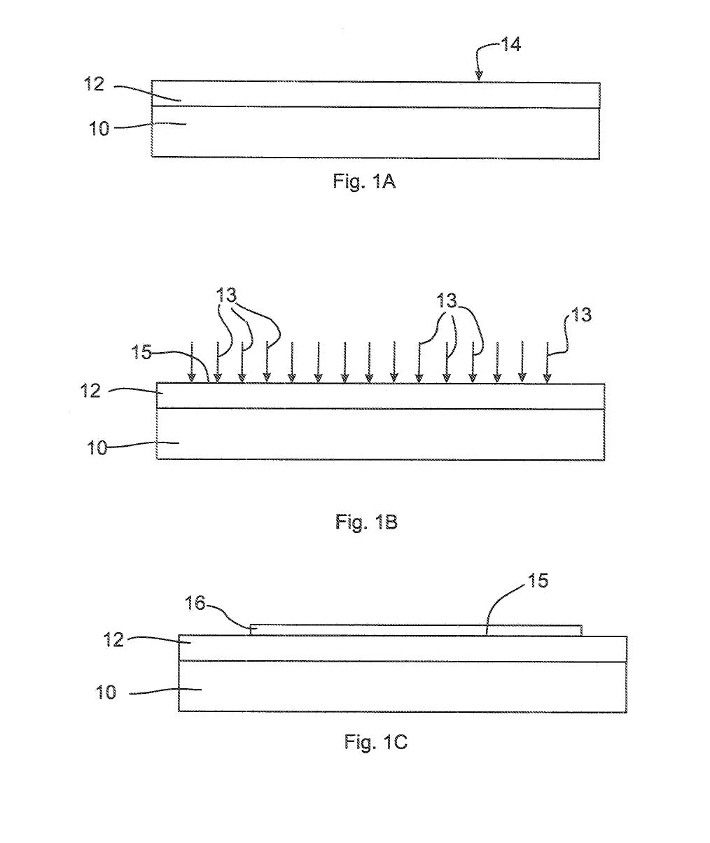

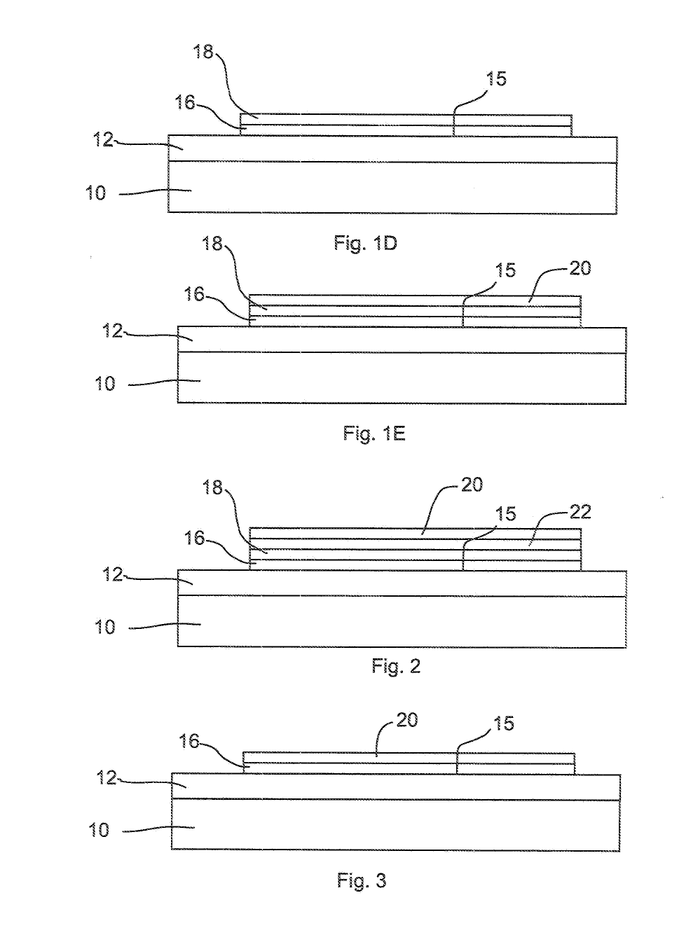

Referring now to FIG. 1A, in a number of variations of the invention, a substrate 10 may be provided and a layer including chrome 12, such as chrome plated layer, may be provided. The layer including chrome may have an exposed surface 14 which may not be conducive to adhering coatings thereto and/or may include a variety of undesirable constituents such as oils, grease and/or dirt thereon.

Referring now to FIGS. 1A-1B, in a number of variations, the exposed surface 14 of the layer including chrome 12 may be activated by exposing the surface 14 to a gas including ionized oxygen 13 to provide an activated surface 15. In one variation, the surface 14 may be exposed to plasma to provide an activated surface. In a number of variations an additional advantage of utilizing a gas including ionized oxygen 13 to activate the surface 14 is that such a process also removes undesirable constituents such as oils, grease and/or dirt from the surface. In one variation, the plasma may be open air plasma. The open-air plasma process utilizes air and does not require the storage of process gases in order to produce a plasma sufficient to activate the surface 14 of the layer including chrome 12. Variations of an open-air plasma process may include flowing air over the surface to be activated in the presence of an electrical arc. In a number of variations a jet stream of air may be flowed over the surface to be activated.

In another variation, the surface 14 of the layer including chrome 12 my be activated by a flame. In another variation, the surface 14 of the layer including chrome 12 may be activated by a corona discharge.

Referring now to FIG. 1C, in a number of variations, a coupling agent 16 may be applied to the activated surface 15 to provide a coupled surface. In one variation, a first primer may be applied and deposited on the activated surface 15 wherein the first primer includes the coupling agent.

In some variations the coupling agent may include a silane coupling agent. In one variation the coupling agent may include aminopropyltriethoxysilane (C₉H₂₃NO₃Si). In some variations the coupling agent may include 3-mercaptopropyltrimethoxysilane (C₉H₁₆O₃SSi). Other variations of a silane coupling agent may include silane compounds including those having two or more hydrolyzable functional groups. Variations of the functional group may include at least one of vinyl, methacryloxy, epoxy, amino, thiol, polysulfide, ureido or isocyanato. A number of variations may include at least one of vinyltrimethoxysilane, vinyl-tris-(2-methoxyethoxy)silane, vinylmethyldimethoxysilane, gamma-methacryloxypropyltrimethoxy silane, beta-(3,4-ethoxycyclohexyl)ethyltrimethoxysilane, gamma-glycidoxypropyltrimethoxysilane, gamma-mercaptopropyltrimethoxysilane, bis-(3-[triethoxy silyl]-propyl)-tetrasulfane, gamma-aminopropyltriethoxysilane, gamma-aminopropyltrimethoxysilane, N-beta-(aminoethyl)-gamma-aminopropyltrimethoxysilane, bis-(gamma-trimethoxysilylpropyl)amine, N-phenyl-gamma-aminopropyltrimethoxysilane, N-beta-(aminoethyl)-gamma-aminopropylmethyldimethoxysilane, gamma-ureidopropyltrimethoxysilane, gamma-isocyanatopropyltriethoxysilane, vinyltriacetoxy silane, 3-glycidyloxypropylmethyldiethoxysilane or 3-glycidyloxypropyltriethoxysilane. Various combinations of silane compounds may also be used. In one variation the silane compound or compounds may be in a solution in an amount ranging from about 0.05% to about 10% by weight of the solution. In one variation the thickness of the coupling layer may be less than 2μ thick.

Referring now to FIG. 1D, in a number of variations, a basecoat or clearcoat layer 18 may be applied to the coupled surface 16. In one variation the clearcoat may be 25-50μ thick.

Referring now to FIG. 1E, in a number of variations, a coating 20 may be applied over the coupled surface 16 and dried so that the coating 20 adheres to the layer including chrome 12. In numerous variations the coating 20 may include at least one of a clearcoat, tinted clearcoat, an opaque paint including pigment, or a primer. In one variation, the coating 20 may be applied to the coupled surface and dried to a thickness ranging from 25-50μ. In one variation the coating 20 may be at least one of an acrylic, urethane or polyester basecoat or clearcoat paint layer.

Referring now to FIG. 2, in a number of variations, a primer 18 may be applied or deposited over the coupling layer prior to applying the coating 20 over the coupled surface 16. In one variation the primer may have a thickness ranging from 5 to 25μ. In one variation the primer may include an aliphatic and/or aromatic polyisocyanate, and isocyanate/silane adduct, and a solvent such as, but not limited to, at least one of them MEK, butyl acetate or xylene. The second primer may also include at least one of a polyol, polyester or poly ethylene.

Referring now to FIG. 3, in a number of variations, a coating 20 may be applied directly on the activated surface 15 of the layer including chrome 12. In one variation, prior to applying the coating 20 over the activated surface 15, a coupling agent 16 may be applied to the activated surface 15.

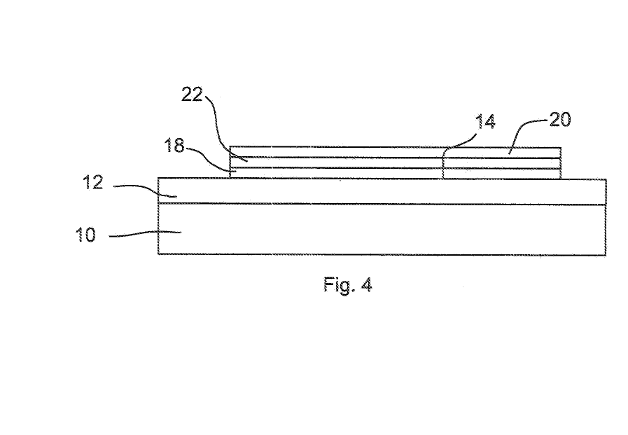

Referring now to FIG. 4, in a number of variations, a method may include applying at least a first primer and a second primer over the layer including chrome which has not been activated prior to applying a coating over the primers so that the coating is adhered to the layer including chrome.

### Experimental Results

Samples were subjected to the following three tests: (1) Initial Adhesion Test; (2) Humidity Test; and (3) Thermal Shock Test. The Initial Adhesion Test involved crosshatching a substrate having plated chrome thereon and a coating over the plated chrome, applying a tape to the coating over the crosshatching, pulling the tape off and then checking to see if any of the coating came off with the tape. If none of the coating comes of with the tape then the sample is considered to have passed the Initial Adhesion Test. The Humidity Test involved placing a sample in a humidity chamber controlled to 38° C. and 100% relative humidity for a period of 240 hours, then crosshatching the sample, applying tape to the crosshatched section of the sample, pulling the tape off of the sample, and checking to see if any of the coating came off with the tape. If none of the coating comes off at the tape the sample is considered to have passed the Humidity Test. The Thermal Shock Test involves freezing the sample down to −30° C. and then subjecting the sample to a steam jet of 100° C. This test simulates the worst case condition for driving a vehicle into a car wash during extremely cold weather. The Thermal Shock Test serves as a highly accelerated life test and predictor of adhesion performance over the life of the part from exposure to elements and car washes. If there is no damage to the sample from the Thermal Shock Test, the sample is considered to have passed Thermal Shock Test.

A chrome plated plastic plaque with an organic coating but without plasma treatment or coupling agents was subjected to each of the three tests but only passed the Initial Adhesion Test. Chrome plated plastic plaques with organic coatings that were plasma treated only showed an improvement in adhesion testing passing the Initial Adhesion Test and the Humidity Test. Samples including plasma treatment with the addition of a silane coupling agent passed all three tests including the Thermal Shock Test. Plastics used in the samples included both ABS (acrylonitrile-butadiene-styrene) and ABS plus PC (acrylonitrile-butadiene-styrene and polycarbonate blend).

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a process comprising: providing a substrate having a layer comprising chrome thereon, the chrome having exposed surface; exposing the layer comprising chrome to a gas comprising ionized oxygen to activate the exposed surface of the chrome to provide an activated surface; contacting the activated surface with a coupling agent to provide a group bonded to the layer comprising chrome to provide a coupled surface; applying a coating over the coupled surface so that the coating is adhered to the layer comprising chrome.

Variation 2 may include a process as set forth in Variation 1 wherein the contacting the activated surface with a coupling agent to provide a group bonded to the layer comprising chrome to provide a coupled surface comprises contacting the activated surface with a composition comprising a silane coupling agent to provide a group comprising R—Si—O bonded to the layer comprising chrome, wherein R is hydrogen, an inorganic group, or organic group; and wherein the applying a coating coupled surface so that the coating is adhered to the layer comprising chrome comprises applying a coating to the layer comprising chrome having the group comprising R—Si—O bonded thereto.

Variation 3 may include a process as set forth in any of Variations 1-2 wherein the gas comprising ionized oxygen comprises a plasma.

Variation 4 may include a process as set forth in Variation 3 wherein the plasma is an open-air plasma.

Variation 5 may include a process as set forth in any of Variations 1-4 wherein the gas comprising ionized oxygen comprises a flame.

Variation 6 may include a process as set forth in any of Variations 1-5 wherein the gas comprising ionized oxygen comprises corona discharge.

Variation 7 may include a process as set forth in any of Variations 1-6 further comprising delaying for 0-up to 96 hours (or any period there between) after the exposing the layer comprising chrome to a gas comprising ionized oxygen before performing the act of applying a coating coupled surface so that the coating is adhered to the layer comprising chrome.

Variation 8 may include a process as set forth in any of Variations 1-7 wherein the providing a substrate having a layer comprising chrome thereon, the chrome having exposed surface comprises plating a layer comprising chrome onto a substrate, and further comprising after the plating a layer comprising chrome onto a substrate delaying at least one month prior to performing the act of exposing the layer comprising chrome to a gas comprising ionized oxygen to activate the exposed surface of the chrome to provide inactivated surface.

Variation 9 may include a process as set forth in any of Variations 1-8 wherein the providing a substrate having a layer comprising chrome thereon, the chrome having exposed surface comprises plating a layer comprising chrome onto a substrate, and further comprising after the plating a layer comprising chrome onto a substrate delaying at least nine months prior to performing the act of exposing the layer comprising chrome to a gas comprising ionized oxygen to activate the exposed surface of the chrome to provide inactivated surface.

Variation 10 may include a process as set forth in any of Variations 1-9 wherein the sane coupling agent comprises at least one of aminopropyltriethoxysilane (C₉H₂₃NO₃Si) or 3-mercaptopropyltrimethoxysilane (C₉H₁₆O₃SSi).

Variation 11 may include a process as set forth in any of Variations 1-10 wherein the coating is a primer.

Variation 12 may include a product as set forth in any of Variations 1-11 wherein the coating is a clear coat, a tinted clear coat, an opaque paint or a primer.

Variation 13 may include a process as set forth in any of Variations 1-12 wherein the contacting the activated surface with a coupling agent to provide a group bonded to the layer comprising chrome to provide a coupled surface contacting the activated surface with a primer having the coupling agent therein.

Variation 14 may include a process as set forth in any of Variations 1-13 wherein the composition comprising a silane coupling agent is a primer.

Variation 15 may include a process as set forth in any of Variations 1-15 further comprising applying a second primer to the coupled surface before performing the act of applying a coating over the coupled surface.

Variation 16 may include a process as set forth in Variations 15 wherein the second primer comprises an isocyanate and silane adduct, at least one of a polyol or polyester or polyethylene, and at least one of a aliphatic or aromatic polyisocyanate.

Variation 17 may include a process as set forth in any of Variations 1-16 wherein the coating is a layer comprising at least one of an acrylic or urethane or polyester basecoat paint.

Variation 18 may include a process comprising: providing a substrate having a layer comprising chrome thereon, the chrome having exposed surface; exposing the layer comprising chrome to a gas comprising ionized oxygen to activate the exposed surface of the chrome to provide an activated surface; applying a coating over the activated surface so that the coating is adhered to the layer comprising chrome, and wherein the coating is at least one of a primer, clear coat, tinted clear coat or opaque paint.

Variation 19 may include a product comprising a layer comprising chrome and having a coupled surface, a primer over the coupled surface and a coating over the primer so that the coating is adhered to the layer including chrome.

Variation 20 may include a product made according to any one of the processes as set forth in Variations 1-19.

The above description of select examples of embodiments of the invention is merely exemplary in nature and, thus, variations or variants thereof are not to be regarded as a departure from the spirit and scope of the invention.

What is claimed is:

1. A process comprising:
providing a substrate having a layer comprising chrome thereon, the chrome having exposed surface;
exposing the layer comprising chrome to a gas comprising ionized oxygen to activate the exposed surface of the chrome to provide an activated surface;
contacting the activated surface with a coupling agent to provide a group bonded to the layer comprising chrome to provide a coupled surface;
applying a coating over the coupled surface so that the coating is adhered to the layer comprising chrome.

2. A process as set forth in claim 1 wherein the contacting the activated surface with a coupling agent to provide a group bonded to the layer comprising chrome to provide a coupled surface comprises contacting the activated surface with a composition comprising a silane coupling agent to provide a group comprising R—Si—O bonded to the layer comprising chrome, wherein R is hydrogen, an inorganic group, or organic group; and wherein the applying a coating coupled surface so that the coating is adhered to the layer comprising chrome comprises applying a coating to the layer comprising chrome having the group comprising R—Si—O bonded thereto.

3. A process as set forth in claim 1 wherein the gas comprising ionized oxygen comprises a plasma.

4. A process as set forth in claim 3 wherein the plasma is an open-air plasma.

5. A process as set forth in claim 1 wherein the gas comprising ionized oxygen comprises a flame.

6. A process as set forth in claim 1 wherein the gas comprising ionized oxygen comprises corona discharge.

7. A process as set forth in claim 3 further comprising delaying from 0-96 hours after the exposing the layer comprising chrome to a gas comprising ionized before performing the act of applying a coating coupled surface so that the coating is adhered to the layer comprising chrome.

8. A process as set forth in claim 1 wherein the providing a substrate having a layer comprising chrome thereon, the chrome having exposed surface comprises plating a layer comprising chrome onto a substrate, and further comprising after the plating a layer comprising chrome onto a substrate delaying at least one month prior to performing the act of exposing the layer comprising chrome to a gas comprising ionized oxygen to activate the exposed surface of the chrome to provide inactivated surface.

9. A process as set forth in claim 1 wherein the providing a substrate having a layer comprising chrome thereon, the chrome having exposed surface comprises plating a layer comprising chrome onto a substrate, and further comprising after the plating a layer comprising chrome onto a substrate delaying at least nine months prior to performing the act of exposing the layer comprising chrome to a gas comprising ionized oxygen to activate the exposed surface of the chrome to provide inactivated surface.

10. A process as set forth in claim 2 wherein the silane coupling agent comprises at least one of aminopropyltriethoxysilane (C₉H₂₃NO₃Si) or 3-mercaptopropyltrimethoxysilane (C₉H₁₆O₃SSi).

11. A process as set forth in claim 1 wherein the coating is a primer.

12. A process as set forth in claim 1 wherein the coating is a clear coat, a tinted clear coat, an opaque paint or a primer.

13. A process as set forth in claim 1 wherein the contacting the activated surface with a coupling agent to provide a group bonded to the layer comprising chrome to provide a coupled surface contacting the activated surface with a primer having the coupling agent therein.

14. A process as set forth in claim 2 wherein the composition comprising a silane coupling agent is a primer.

15. A process as set forth in claim 14 further comprising applying a second primer to the coupled surface before performing the act of applying a coating over the coupled surface.

16. A process as set forth in claim 15 wherein the second primer comprises an isocyanate and silane adduct, at least one of a polyol or polyester or polyethylene, and at least one or a aliphatic or aromatic polyisocyanate.

17. A process as set forth in claim 16 wherein the coating is a layer comprising at least one of an acrylic or urethane or polyester basecoat paint.

18. A process comprising:
providing a substrate having a layer comprising chrome thereon, the chrome having exposed surface;
exposing the layer comprising chrome to a gas comprising ionized oxygen to activate the exposed surface of the chrome to provide an activated surface;
applying a coating over the activated surface so that the coating is adhered to the layer comprising chrome, and wherein the coating is at least one of a primer, clear coat, tinted clear coat or opaque paint.

19. A method comprising applying at least a first primer and a second primer over a layer including chrome which has not been activated and thereafter applying a coating over the first primer and a second primer so that the coating is adhered to the layer including chrome.

20. A product comprising a layer comprising chrome and having a coupled surface, a primer over the coupled surface and a coating over the primer so that the coating is adhered to the layer including chrome.
